(19) United States
(12) Patent Application Publication
(10) Pub. No.: US 2008/0101382 A1
(43) Pub. Date: May 1, 2008

(54) EFFICIENT METHOD FOR DISCOVERING PATH MTU FOR TCP CONNECTIONS

(76) Inventors: Dwip N. Bannerjee, Austin, TX (US); Gopala K. Shantala, Bangalore (IN); Venkat Venkatsubra, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/553,020

(22) Filed: Oct. 26, 2006

(51) Int. Cl. H04L 12/56

(52) U.S. Cl. 370/400; 370/395.52

(57) ABSTRACT

A method for efficiently determining the path maximum transmission unit (MTU) during a handshake between a source host and a target host across a computer network. During the handshake, each router receives the SYN (synchronization) packet transmitted from the source host, and each router updates the value of the path MTU within the SYN packet when the path MTU value is greater than the MTU of the router. When the SYN packet reaches the target host, the target host also updates the value of the path MTU if the value of the path MTU within the SYN packet is greater than that of the target host. With this sequential checking and updating of the path MTU against their MTUs, the combination of the routers en-route and the target host ensures that the final path MTU is equal to or smaller than the smallest MTU of the various components/networks along the path.

### BACKGROUND OF THE INVENTION

1. Technical Field

The present invention generally relates to computer networks and in particular to data transfer in computer networks. Still more particularly, the present invention relates to establishing path maximum transmission unit (MTU) for data transfer in computer networks.

2. Description of the Related Art

When an Internet Protocol (IP) source device (or source host) wishes to transfer data to a target/destination host, the data is transmitted as a series of IP datagrams along a network path. The network path may consist of multiple networks separated by routers, with each network supporting a different size datagram. It is usually preferable for the datagrams being transmitted to have the largest size that does not require fragmentation anywhere along the path from the source to the target/destination. This datagram size is referred to as the Path MTU (Maximum Transmission Unit), and is equal to the smallest of the MTUs of each network hop in the path.

Path MTU Discovery is a mechanism used by an IP host to choose a datagram size that will not result in fragmentation. In this mechanism, a source host sends a datagram of size equal to the local network's MTU, by setting the DF (don't fragment) bit in the IP header. When a router in the path is unable to deliver the datagram to the next network hop because the size of the datagram is larger than the size supported within the next network hop, the router returns an Internet Control Message Protocol (ICMP) “Destination Unreachable” message to the source with a code representing “fragmentation needed and DF set.” Some routers also provide next hop MTU information in the ICMP packets. Upon receiving the ICMP packet, the source host reduces the datagram size, and sends the size-adjusted datagram with the DF bit set. This process of receiving ICMP packets, resizing and retransmitting the datagrams continues until the datagram becomes small enough to pass through the entire path (from source to destination) without fragmentation.

However, there are several problems with the above method for Path MTU discovery. A first problem is that network administrators typically block transmission of all ICMP messages within their networks. This blocking of all ICMP messages makes the process of determining the Path MTU difficult for the source host. A second problem is that the ICMP method of determining the Path MTU takes multiple iterations and adds latency to and requires more bandwidth for the data transfer.

An alternate method for Path MTU Discovery has even proposed using a new IP (Internet Protocol) option. This alternate method also has a number of drawbacks, including: (1) the alternate method works only for IPv6, while many networks still operate with IPv4 addressing format. Thus, changes are required in both the end systems to support the new IP option; and (2) IPv6 is a new IP option and thus legacy firewalls tend to filter out packets with IP options, which present a conflict (i.e., due to a lack of familiarity) with the firewalls.

In light of the foregoing, the present invention appreciates the importance of an efficient method to determine Path MTU without requiring changes on the end systems and without presenting a conflict to firewalls.

### SUMMARY OF THE INVENTION

Disclosed is a method, system and computer program product for efficiently determining the path maximum transmission unit (MTU) during a handshake operation between a source host and a target host across a computer network. In particular, an MTU utility executing within each router dynamically updates the path MTU based on the MTU of the next hop within the overall path. During the handshake, each router en-route (i.e., the routers connecting the source host to the target host) receives the SYN (synchronization) packet transmitted from the source host and the routers sequentially confirm that the path MTU within the SYN packet is less than or equal to the MTU of the next network hop within the path. With this sequential checking and updating process during the single SYN transmission, the combination of routers ensures that the final path MTU is equal to (or smaller than) the smallest MTU of the following network components within the path: (1) the source host; (2) the target host; and (3) the routers en-route.

The source host transfers MTU information by sending a transmission control protocol (TCP) SYN packet with a maximum segment size (MSS) field in the TCP header set to that of the source network. The MSS value is the Path MTU minus a pre-established constant to adjust for the size of the header information within the packet. Each router en-route examines the MSS field, and if the MSS value within the SYN packet is larger than the MSS value of the router, the router adjusts (or updates) the value of the MSS field to that of the router's MSS. When the TCP packet eventually reaches the target host, the target host computes the Path MTU as the received MSS plus the pre-established constant. The target host then advertises this MSS back to the source host within a TCP SYN-ACK packet. Similarly, the source host computes the Path MTU from the MSS value received. The Path MTU is then utilized to efficiently guide the transfer of datagrams without fragmentation between the source host and the target host.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram of a network router within which the features of an illustrative embodiment may be advantageously implemented;

FIG. 2 is a block diagram representation of a computer network system, according to an illustrative embodiment;

FIG. 3 is an example block diagram representation of a Path MTU discovery network system, according to an illustrative embodiment; and

FIG. 4 illustrates the process completed by a Path MTU discovery system when executing the maximum transmission unit (MTU) utility at network routers, according to an illustrative embodiment.

### DETAILED DESCRIPTION OF AN ILLUSTRATIVE EMBODIMENT

The present invention provides a method, system and computer program product for efficiently determining the path maximum transmission unit (MTU) during a handshake operation between a source host and a target host across a computer network. In particular, an MTU utility executing within each router dynamically updates the path MTU based on the MTU of the next hop within the overall path. During the handshake, each router en-route (i.e., the routers connecting the source host to the target host) receives the SYN (synchronization) packet transmitted from the source host and the routers sequentially confirm that the path MTU within the SYN packet is less than or equal to the MTU of the next network hop within the path. With this sequential checking and updating process, the combination of routers ensures, via a single SYN transmission, that the final path MTU is equal to (or smaller than) the smallest MTU of the following network components within the path: (1) the source host; (2) the target host; and (3) the routers en-route.

The source host transfers MTU information by sending a transmission control protocol (TCP) SYN packet with a maximum segment size (MSS) field in the TCP header set to that of the source network. The MSS value is the Path MTU minus a pre-established constant to adjust for the size of the header information within the packet. Each router en-route examines the MSS field, and if the MSS value within the SYN packet is larger than the MSS value of the router, the router adjusts (or updates) the value of the MSS field to that of the router's MSS. When the TCP packet eventually reaches the target host, the target host computes the Path MTU as the received MSS plus the pre-established constant. The target host then broadcasts this MSS value back to the source host within a TCP SYN-ACK packet. Similarly, the source host computes the Path MTU from the MSS value received. The Path MTU is then utilized to efficiently guide the transfer of datagrams without fragmentation between the source host and the target host.

In the following detailed description of exemplary embodiments of the invention, specific exemplary embodiments in which the invention may be practiced are described in sufficient detail to enable those skilled in the art to practice the invention, and it is to be understood that other embodiments may be utilized and that logical, architectural, programmatic, mechanical, electrical and other changes may be made without departing from the spirit or scope of the present invention. The following detailed description is, therefore, not to be taken in a limiting sense, and the scope of the present invention is defined only by the appended claims.

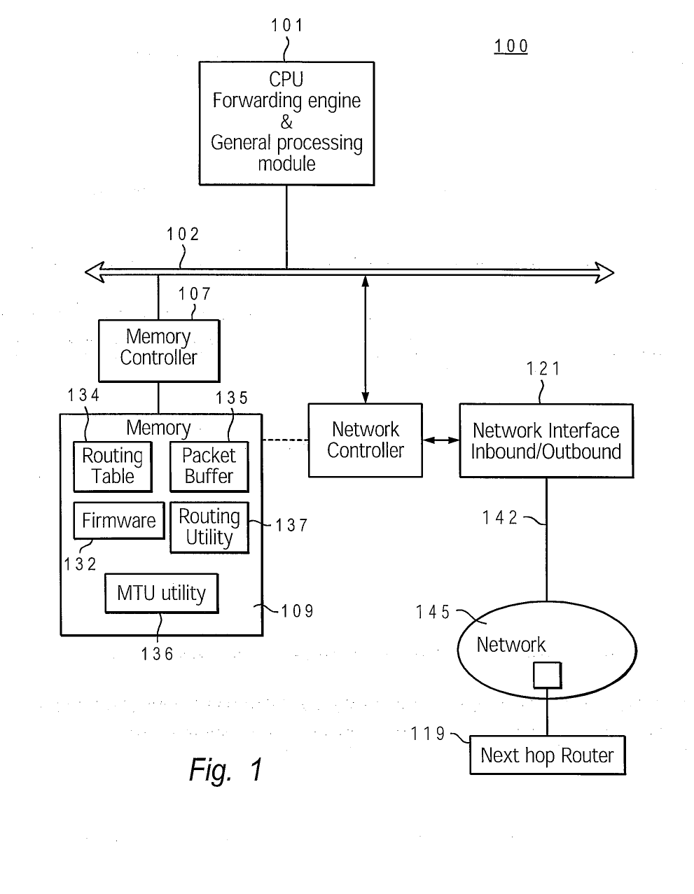

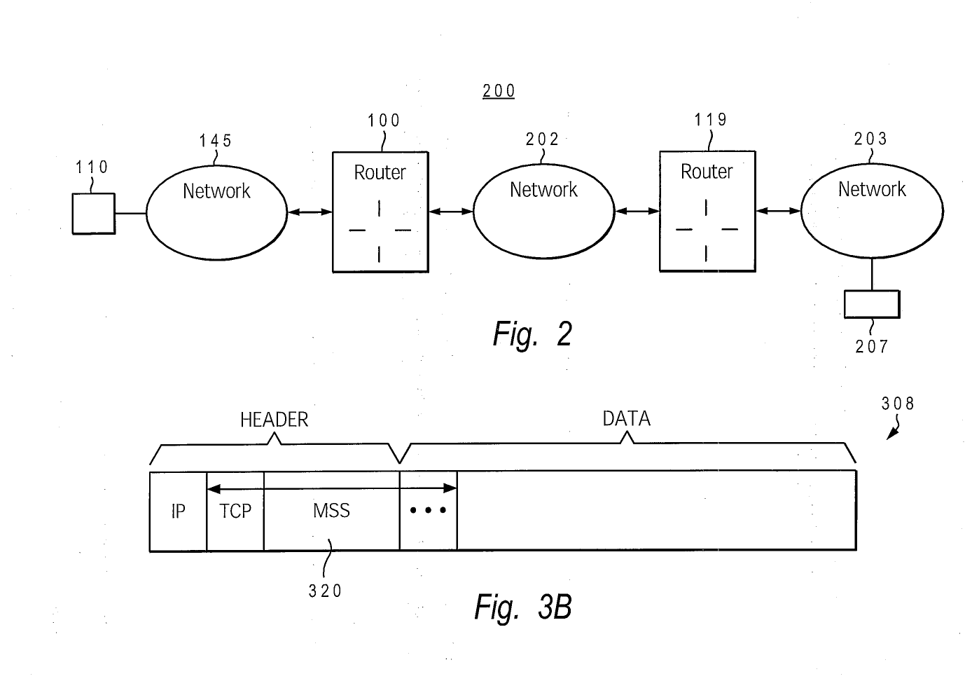

Within the descriptions of the figures, similar elements are provided similar names and reference numerals as those of the previous figure(s). Where a later figure utilizes the element in a different context or with different functionality, the element is provided a different leading numeral representative of the figure number (e.g., 1xx for FIG. 1 and 2xx for FIG. 2). The specific numerals assigned to the elements are provided solely to aid in the description and not meant to imply any limitations (structural or functional) on the invention.

It is also understood that the use of specific parameter names are for example only and not meant to imply any limitations on the invention. The invention may thus be implemented with different nomenclature/terminology utilized to describe the above parameters, without limitation.

With reference now to the figures, FIG. 2 illustrates a block diagram of a network system within which features of the invention may be practiced. Network system 200 comprises several sub-networks, i.e., network 145, network 202, and network system 203. Additionally, network system 200 consists of router 100 and router 119 which inter-connect the sub-networks. Source host 110 connects to network 145 and target host 207 connects to network 203. The combination of sub-networks and connecting routers provides a communication path between source host 205 and destination host 207. As shown, the path connecting source host 110 to target host 207 begins with network 145 (to which source host 110 is connected and/or affiliated), which is connected to router 100, which is further connected to (next hop) network 202. Further, the path continues with (next hop) router 119, through network 203 and ends with target host 207.

In network system 200, the medium connecting a network and a router may be a wireless or wired channel. The sub-networks may take various forms, which may include the following: (1) a local area network (LAN); (2) a metropolitan area network (MAN); and (3) a wide area network (WAN), e.g., the Internet. Each sub-network supports data transmission via specific MTUs, which are assumed to be defined within the leading/preceding router, in the described embodiments.

Turning now to FIG. 1, wherein is illustrated an example router, which is assumed to be representative of any one of the routers within FIG. 2, but is specifically described as router 100 in network system 200 to simplify the description herein. Router 100 comprises an integrated central processing unit (CPU) 101 coupled to system bus/interconnect 102. Also coupled to system bus/interconnect 102 is memory controller 107 which controls access to memory 109.

Router 100 further comprises network controller 120 to which is connected network interface inbound/outbound device (NIIOD) 121 by which router 110 connects to and communicates with an external device or network (such as the Internet or network 145) via wired or wireless connection 142. NIIOD 121 may be provided as a set of interface cards (sometimes referred to as “line cards”). Generally, these interface cards control the sending and receiving of data packets over network 145.

Router 100 generally performs two main functions: (1) control path routines; and (2) data path control (switching). Router 100 maintains and manipulates routing tables 134, and router 110 listen for updates and change the routing tables to reflect the new network topology. Typically, packets are received at inbound network interface 121. These packets are then processed by CPU 101 then stored in the packet buffering module 135. The packets are then forwarded to the outbound network interface 121 that transmits the packet to the next hop router 118. CPU 101 performs a number of functions which include path computations, and routing table maintenance.

Router 100 adjusts the Time-to-live (TTL) field in the received packets to prevent packets from circulating endlessly. Router 100 also checks the validity of the data based on the checksum and incrementally updates the checksum before forwarding the packet. The forwarding of packets is controlled by the forwarding engine (within CPU 101), whose basic function is to generate next-hop addresses. Additionally, the forwarding engine performs basic error checks, generates the appropriate header, and forwards the IP packet (along with the appropriate header) to the appropriate interface.

Those of ordinary skill in the art will appreciate that the hardware depicted in FIG. 1 may vary. Thus, the depicted example is not meant to imply architectural limitations with respect to the present invention.

Various features of the invention are provided as software code stored within memory 109 or other storage and executed by CPU 101. Among the software code are code for providing the above described router functions (routing table, packet buffer, etc), code for enabling network connection and communication via Network Interface Inbound/Outbound Device (NIID) 121, and more specific to the invention, code for enabling the Path Maximum Transmission Unit (MTU) determination features described below. For simplicity, the collective body of code that enables the Path MTU determination features is referred to herein as the MTU utility. In actual implementation, the MTU utility may be added to existing router code to provide the Path MTU functionality described herein.

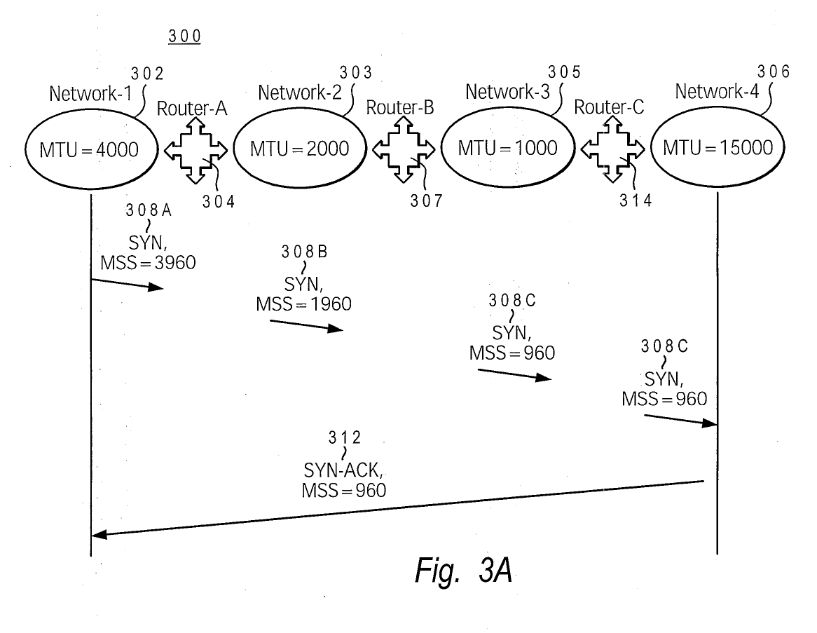

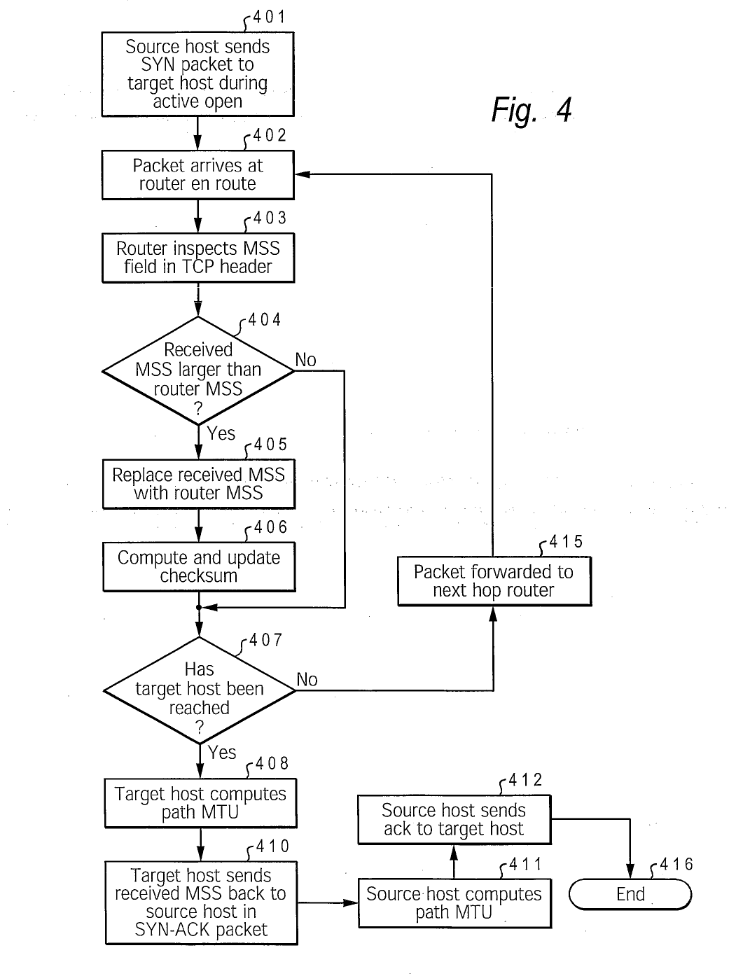

Thus, as shown by FIG. 1, in addition to the above described hardware components, router 100 further comprises a number of software components, including firmware 132 and one or more software applications, including routing utility 137 and MTU utility 136. In implementation, firmware 132, router utility 137 and MTU utility 136 are located within memory 109 and executed on CPU 101. According to the illustrative embodiment, execution of MTU utility 136 is triggered whenever a SYN packet is received by router 100. CPU 101 executes MTU utility 136, which enables router 110 to complete a series of functional processes, which are described in greater detail below and illustrated by FIGS. 3-4.

Execution of MTU utility 136 allows router 100 to update the MSS field in the header of the SYN packet whenever MTU utility 136 determines that an update is necessary. In the described embodiment, MTU utility 136 is integrated into the various routers in network system 200. Integration of MTU utility 136 within each router enables each router to carry out a specific set of functions during the handshake process of establishing a path between a source and a destination/target host. Among these functions enabled by execution of MTU utility includes (a) comparing the MSS field in the received SYN packet with the locally provided MSS value of the next hop network; (b) dynamically updating the MSS field in the SYN packet header to the smaller of the MSS value within the received SYN packet and the locally provided MSS value; and (c) forwarding the SYN packet through a next hop network to a next router or to the target source.

With reference again to FIG. 2, in network system 200, whenever source host 110 wishes to transfer data to target host 207, source host 110 initiates an active open and sends a SYN (synchronize) packet to target host 207 in Network 203 during the active open. An active open is the first phase of the TCP 3-way handshake, which establishes and negotiates the actual TCP connection over which data will be sent. A SYN is a type of packet used by the TCP when initiating a new connection to synchronize the sequence numbers on two connecting computer devices. Before host 110 attempts to connect with target host 207, target host 207 must first bind to a port to open the port up for connections. This bind process is referred to as a passive open. Once the passive open is established, host 110 may initiate an active open.

To establish a connection, the 3-way (or 3-step) handshake occurs as follows: (1) The active open is performed by source host 110 sending a SYN to target host 207; (2) As an acknowledgement to the receipt of the SYN, target host 207 replies with a SYN-ACK; and (3) Finally, source host 110 sends an ACK (an acknowledgement and synchronization to the receipt of the SYN-ACK) back to target host 207. Once the final step takes place, both host 110 and target host 207 have received an acknowledgement of the connection and may begin transmitting data over the connection. This handshake is modified by the processes of the invention to enable a determination of the path MTU during transmission of the single SYN in the first step of the 3-step handshake.

According to the described embodiment, during the active open, source host 110 transfers MTU information by sending a SYN packet in which the maximum segment size (MSS) field in the TCP header is set. The MSS value is typically obtained from an initiating host, for example, source host 110 or calculated as the outgoing interface MTU minus the sum of IP and TCP headers, as described below. The SYN packet sent by source host 110 encounters one or more routers (routers en-route) along the path that connects source host 110 to target host 207. In network system 200, the SYN packet encounters router 100 and router 119 en-route to target host 207.

MTU utility within each router encountered on the connection path 212 of the Path MTU discovery system inspects the MSS field in the TCP header of the datagram to determine whether the received MSS value is larger than the router's MSS. Whenever router 100 receives a SYN packet sent by host 110 or by another router, router 100 inspects the MSS field in the TCP header to determine whether the received MSS value is larger than the MSS of router 100. If the received MSS is less than or equal to the MSS of router 100, router 100 forwards the SYN packet along the path without modifying the MSS field in the packet header. If the received MSS is larger than the MSS of router 100, the received MSS is replaced by the MSS of router 100 in the MSS field of the SYN packet. The MSS of router 100 is equal to the MSS of the next hop network. Once the SYN packet arrives at target host 207, target host 207 computes the Path MTU according to the following formula:

Path MTU=MSS_{At target host}+pre-established header size (B)

According to the invention, the pre-established header size is a set value based on the transmission protocol being utilized. Within the described embodiment, the header size is assumed to be 40, representing the header size for a standard TCP/IP datagram. However, those skilled in the art appreciate that a different header size may be utilized for transmissions utilizing different protocols (or future updates to TCP/IP), and that use of alternate header sizes in determining the path MTU fall within the general scope of the invention. Following computation of the path MTU, target host 207 sends the received MSS back to source host 110 in a SYN-ACK packet. Source host 110 computes the Path MTU based on the MSS value sent by target host 207. Ultimately, this Path MTU will be utilized to guide the transfer of data without fragmentation between source host 110 and target host 207.

FIG. 3A illustrates an example of the Path MTU discovery system when executing MTU utility 136, according to the described embodiment. The example shows Path MTU discovery, which occurs at the time of establishing the connection between a source host (e.g., host 110) coupled to/within network-1 302 and a target host (e.g., host 207) coupled to/within network-4 306. The connection path also consists of router-A 304, network-2 303, router-B 307, network-3 305, and router-C 314.

According to the illustrated embodiment, source host 110 within network-1 302 sends SYN 308A with MSS value set to 3960 (i.e., MTU of Network-1 302—IP header size—TCP header size) to target host 207 in network-4 306. As previously discussed, a header size of 40 is assumed within the various illustrations of the invention. Thus value of the MTU of network-1 302 is depicted as 4000. When SYN 308A reaches router-A 304, router-A 304 examines the MSS value specified in the TCP header and since the MSS value in SYN 308A is greater than the MSS value of network-2 303, router-A 304 changes the MSS value in SYN 308A to 1960 and forwards the packet as SYN 308B. Similarly router-B 307 changes the MSS value in the SYN 308B to 960 and forwards the packet as SYN 308C. However, router-C 314 does not change the MSS value in SYN 308C because the MSS value specified in SYN 308C is less than the MSS value of network-4 306. The packet is forwarded to target host 207 as SYN 308C. FIG. 3B illustrates an example SYN packet, which represents SYN 308, and includes a TCP and IP header and a data component. Within TCP header is MSS filed 320, which is accessed and potentially updated by MTU utility executing within the various routers.

On receiving SYN 308C, target host 207 sends SYN-ACK 312 back to host 110 with the MSS value set to 960. SYN-ACK 312 is sent to notify source host 110 of the receipt of SYN 308C by target host 207. Source host 110 now uses the MSS value as 960 for the entire session with target host 207. Source host 110 and target host 207 both compute the Path MTU, which is then utilized as the maximum size for all future datagrams transmitted on the established connection. According to the described embodiment, the connection is established at the moment target host 207 receives an ACK packet sent by host 110.

FIG. 4 illustrates the process completed by the Path MTU discovery system when executing MTU utility 136 within routers, according to the described embodiment. The process begins at block 401, at which host 110 sends a SYN packet to target host 207 during an active open. At block 402, the SYN packet sent by host 110 arrives at a router en-route. The router then inspects the MSS field in the TCP header, as shown at block 403. The router determines, at block 404, whether the received MSS value is larger than the router's MSS. If the received MSS is less than or equal to the router's MSS, the process moves to block 407. If the received MSS is larger than the router's MSS, the received MSS is replaced by the router's MSS in the MSS field of the SYN, as shown at block 405. The router's MSS is equal to the MSS at the next hop network. At block 406, the checksum is updated according to the following formula:

new_checksum=old_checksum−˜old val−new_{—}val (A)

In equation A, old_val is the current/received two (2) byte MSS value in the SYN packet, and new_val is the (new) value with which the router replaces old_val. In addition, ‘˜’ is a symbol which means ‘the one's complement of’. Following the checksum update, the router determines whether the associated (next hop) network includes target host 207, at block 407. If target host 207 has not been reached, the SYN is forwarded to the next hop router, as shown at block 415. Following block 415, the process then returns to block 402. However, if target host 207 has been reached, target host 207 computes the Path MTU, according to the following formula:

Path MTU=MSS_{at target host}+pre-established header size. (B)

This calculation of Path MTU is illustrated by block 408. Target host 207 then sends the received MSS back to source host 110 in a SYN-ACK packet, at block 410. Source host 110 computes the Path MTU based on the MSS value sent by target host 207, as shown at block 411, and acknowledges receipt of the SYN-ACK at block 412. The process then ends at block 416.

In the flow chart (FIG. 4) above, while the process steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

By triggering the Path MTU discovery system during connection establishment, the MTU utility efficiently determines Path MTU while requiring no major or structural changes on the end systems and without presenting a conflict to firewalls. Effectively, the complete path MTU/MSS is discovered by a single SYN packet.

As a final matter, it is important that while an illustrative embodiment of the present invention has been, and will continue to be, described in the context of a fully functional computer system with installed software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as floppy disks, hard disk drives, CD ROMs, and transmission type media such as digital and analogue communication links.

While the invention has been particularly shown and described with reference to a preferred embodiment, it will be understood by those skilled in the art that various changes in form and detail may be made therein without departing from the spirit and scope of the invention.

What is claimed is:

1. A router comprising:
a processing component;
means for receiving network packets from a first network and transmitting network packets to a second network;
a storage facility coupled to the processing component and including executable code for completing a series of functions including:
detecting a receipt of a synchronization (SYN) packet, which includes a maximum segment size MSS field containing an MSS value;
determining if the MSS value is larger than a local MSS value of a next network hop;
when the MSS value is larger than the local MSS value, dynamically updating the MSS value within the MSS field to that of the local MSS value; and
forwarding the SYN packet to a next component within a network path.

2. The router of claim 1, further comprising:
a table of network connectivity data;
means for parsing a header of the SYN packet;
wherein said means for determining comprises:
means for determining the next network hop to which the SYN packet is to be routed from information within the header; and
means for looking up an MSS size of the next network hop from within the table of network connectivity data.

3. The router of claim 2, wherein when the table provides a maximum transmission unit (MTU) value for the next network hop, said means for determining further comprises:
means for calculating the local MSS value from the MTU value and a pre-established header size value.

4. The router of claim 3, wherein said means for calculating comprises means for subtracting the pre-established header size value from the MTU value to yield the local MSS value.

5. A network comprising:
a router configured according to claim 1;
a source host that generates the SYN packet including therein a source host MSS value; and
a target host that receives a SYN packet, which includes therein a final MSS value that is a smaller of the source host MSS value and the local MSS value.

6. The network of claim 5, wherein the SYN packet is a Transmission Control Protocol/Internet Protocol (TCP/IP) SYN packet and the router and network transmit data according to TCP/IP.

7. The network of claim 5, wherein said target host comprises:
means for receiving the SYN packet with the final MSS value;
means for generating a SYN-ACK in response to receipt of the SYN packet;
means for encapsulating the final MSS value within the SYN-ACK; and
means for transmitting the SYN-ACK with the final MSS value to the source host.

8. The network of claim 7, said source host further comprising:
means for receiving the SYN-ACK with the final MSS value; and
means for issuing an acknowledgment to the target host of the receipt of the SYN-ACK, wherein said acknowledgement completes a handshake operation and established a connection path between the source host and the target host with a path MTU calculated based the final MSS value.

9. The network of claim 8, wherein said target host and said source host further comprises:
means for calculating the path MTU by adding the final MSS value to the pre-established header size value; and
means for subsequently generating packets for transmission on the connection path between the source host and the target host, wherein the packets are generated to be of a size smaller than or equal to the path MTU.

10. The network of claim 6, wherein said router further comprises:
a table of network connectivity data;
means for parsing a header of the SYN packet; and
wherein said means for determining comprises:
means for determining the next network hop to which the SYN packet is to be routed from information within the header; and
means for looking up an MSS size of the next network hop from within the table of network connectivity data.

11. The network of claim 10, wherein when the table provides a maximum transmission unit (MTU) value for the next network hop, said means for determining further comprises:
means for calculating the local MSS value from the MTU value and a pre-established header size value.

12. The network of claim 11, wherein said means for calculating comprises means for subtracting the pre-established header size value from the MTU value to yield the local MSS value.

13. A method comprising:
receiving a synchronization (SYN) packet including an MSS field containing an MSS value;
determining if the MSS value is larger than a local MSS value of a next network hop;
when the MSS value is larger than a local MSS value of a next network hop, dynamically updating the MSS value within the MSS field to that of the local MSS value; and
forwarding the SYN packet including therein a final MSS value, which is the smallest of the MSS value and the local MSS value.

14. The method of claim 13, further comprising:
parsing a header of the SYN packet for the MSS value; and
wherein said determining comprises:
determining the next network hop to which the SYN packet is to be routed from information within the header; and
looking up an MSS size of the next network hop from within a table of network connectivity data.

15. The method of claim 14, wherein when the table provides a maximum transmission unit (MTU) value for the next network hop, said determining further comprises:
calculating the local MSS value from the MTU value and a pre-established header size value.

16. The method of claim 15, wherein said calculating comprises subtracting the pre-established header size value from the MTU value to yield the local MSS value. looking up the local MSS value within a table of network data.

17. A computer program product comprising a computer readable medium and program code on the computer readable medium for completing the processes of claim 13.

18. A computer program product comprising a computer readable medium and program code on the computer readable medium for completing the processes of claim 14.

19. A computer program product comprising a computer readable medium and program code on the computer readable medium for completing the processes of claim 15.

20. A computer program product comprising a computer readable medium and program code on the computer readable medium for completing the processes of claim 16.
